(19) United States
(12) Patent Application Publication
(10) Pub. No.: US 2018/0136844 A1
(43) Pub. Date: May 17, 2018

(54) ARITHMETIC CIRCUIT AND A SEMICONDUCTOR DEVICE

(71) Applicant: SK hynix Inc., Icheon-si Gyeonggi-do (KR)

(72) Inventor: Chang Hyun KIM, Seoul (KR)

(73) Assignee: SK hynix Inc., Icheon-si Gyeonggi-do (KR)

(21) Appl. No.: 15/467,675

(22) Filed: Mar. 23, 2017

(30) Foreign Application Priority Data
Nov. 11, 2016 (KR) 1020160150498

(51) Int. Cl. G06F 3/06

(52) U.S. Cl. CPC G06F 3/0604; G06F 3/0679; G06F 3/0659

(57) ABSTRACT

A semiconductor device may include an input control circuit, a first operation control circuit, an arithmetic circuit and a second operation control circuit. The input control circuit may generate a read signal, write signal, a read address, and write address based on an external control signal. The first operation control circuit may control a first cell array so that first read data and second read data stored in the first cell array are outputted based on the read signal and the read address. The arithmetic circuit may perform a predetermined arithmetic operation to generate first write data and second write data based on the first read data and the second read data. The second operation control circuit may control a second cell array so that the first write data and the second write data are stored in the second cell array based on the write signal and the write address.

### CROSS-REFERENCE TO RELATED APPLICATION

The present application claims priority under 35 U.S.C 119(a) to Korean Application No. 10-2016-0150498, filed on Nov. 11, 2016, which is incorporated herein by references in its entirety.

### BACKGROUND

### 1. Technical Field

Embodiments of the present disclosure may generally relate to semiconductor devices, and more particularly, to semiconductor devices and an arithmetic circuit.

### 2. Related Art

Each semiconductor system may consist of a semiconductor device for storing data and a controller for controlling operations of the semiconductor device. After the controller receives data from the semiconductor device to perform operations, for example, arithmetic logic operations for specific functions, the controller may apply the data to the semiconductor device.

### SUMMARY

According to an embodiment, a semiconductor device may be provided. The semiconductor device may include an input control circuit, a first operation control circuit, an arithmetic circuit and a second operation control circuit. The input control circuit may be configured to generate a read signal, a read address, a write signal and a write address based on an external control signal. The first operation control circuit may be configured to control a first cell array so that first read data and second read data stored in the first cell array are outputted based on the read signal and the read address. The arithmetic circuit may be configured to perform a predetermined arithmetic operation to generate first write data and second write data based on the first read data and the second read data. The second operation control circuit may be configured to control a second cell array so that the first write data and the second write data may be stored in the second cell array based on the write signal and the write address.

According to an embodiment, a semiconductor device may include an input control circuit, a first operation control circuit, an arithmetic circuit and a second operation control circuit. The input control circuit may be configured to generate a read signal, a read address, a write signal and a write address based on an external control signal. The first operation control circuit may be configured to control a first cell array so that first read data stored in the first cell array may be outputted based on the read signal and the read address. The arithmetic circuit may be configured to perform a predetermined arithmetic operation to generate first write data and second write data based on the first read data and second read data. The second operation control circuit may be configured to control a second cell array so that the first write data and the second write data may be stored in the second cell array based on the write signal and the write address.

According to an embodiment, a semiconductor device may include an input control circuit, an arithmetic circuit and a first operation control circuit. The input control circuit may be configured to generate a first read signal, a first read address, a second read signal, a second read address, a first write signal, a first write address, a second write signal and a second write address based on an external control signal and a mode signal. The arithmetic circuit may be configured to perform a predetermined arithmetic operation to generate first write data based on the first read data if the mode signal has a first logic level. The arithmetic circuit may be configured to perform the predetermined arithmetic operation to generate second write data based on the second read data if the mode signal has a second logic level. The first operation control circuit may be configured to control a first cell array so that the first read data stored in the first cell array are outputted based on the first read signal and the first read address if the mode signal has the first logic level. The first operation control circuit may be configured to control the first cell array so that the second write data may be stored in the first cell array based on the second write signal and the second write address if the mode signal has the second logic level.

### BRIEF DESCRIPTION OF THE DRAWINGS

FIG. 1 is a block diagram illustrating a representation of an example of a configuration of a semiconductor device according to an embodiment.

FIG. 2 is a block diagram illustrating a representation of an example of a configuration of an example of an input control circuit included in the semiconductor device of FIG. 1.

FIG. 3 is a block diagram illustrating a representation of an example of a configuration of an example of an arithmetic circuit included in the semiconductor device of FIG. 1.

FIG. 4 is a timing diagram illustrating a representation of an example of an operation of the semiconductor device illustrated in FIG. 1.

FIG. 5 is a block diagram illustrating a representation of an example of a configuration of a semiconductor device according to an embodiment.

FIG. 6 is a block diagram illustrating a representation of an example of a configuration of a semiconductor device according to an embodiment.

FIG. 7 is a block diagram illustrating a representation of an example of a configuration of an electronic system employing at least one of the semiconductor devices illustrated or discussed with regards to FIGS. 1, 5 and 6.

### DETAILED DESCRIPTION

Various embodiments of the present disclosure will be described hereinafter with reference to the accompanying drawings. However, the embodiments described herein are for illustrative purposes only and are not intended to limit the scope of the present disclosure.

Various embodiments may be directed to semiconductor devices including arithmetic circuits.

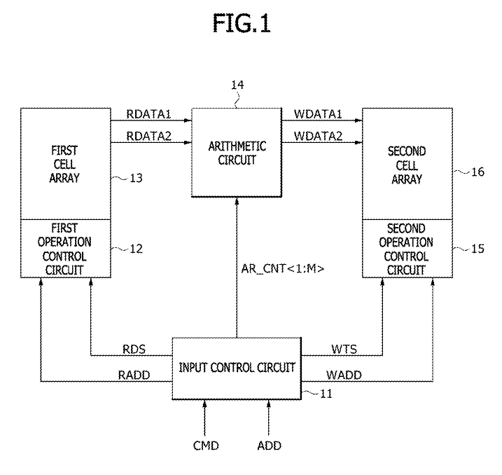

Referring to FIG. 1, a semiconductor device according to an embodiment may include an input control circuit 11, a first operation control circuit 12, a first cell array 13, an arithmetic circuit 14, a second operation control circuit 15 and a second cell array 16.

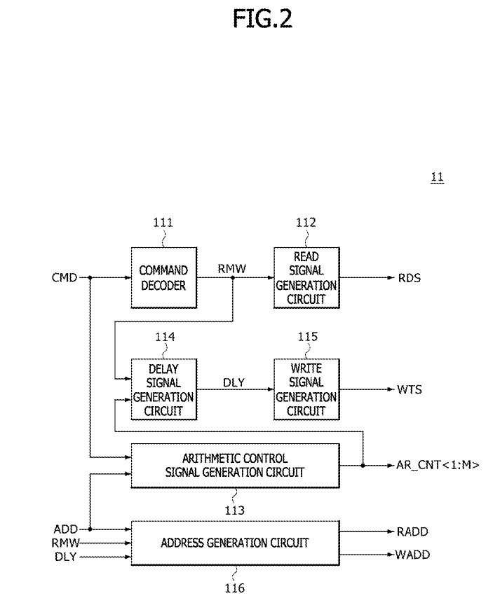

The input control circuit 11 may generate a read signal RDS, a read address RADD, a write signal WTS, a write address WADD and an arithmetic control signal AR_CNT<1:M> in response to a command CMD and an address ADD. In some embodiments, the command CMD and the address ADD may be transmitted through the same signal line. Each of the command CMD and the address ADD may be a signal including a plurality of bits according to the embodiments. The input control circuit 11 may decode the command CMD to generate the read signal RDS and the write signal WTS. The read signal RDS may be enabled to perform a read operation of the first cell array 13. The write signal WTS may be enabled to perform a write operation of the second cell array 16. The input control circuit 11 may decode the address ADD to generate the read address RADD and the write address WADD. The read address RADD may include a plurality of bits according to the embodiments. At least one among cells included in the first cell array 13 may be selected according to a logic level combination of bits included in the read address RADD, and data of the selected cell of the first cell array 13 may be read out while the read signal RDS is enabled. The write address WADD may include a plurality of bits according to the embodiments. At least one among cells included in the second cell array 16 may be selected according to a logic level combination of bits included in the write address WADD, and data may be stored into the selected cell of the second cell array 16 while the write signal WTS is enabled. In some embodiments, the arithmetic control signal AR_CNT<1:M> may be provided from an external device or may be generated in the semiconductor device. The arithmetic control signal AR_CNT<1:M> may be generated from a signal which is inputted through at least one of the command CMD and the address ADD according to the embodiments. A configuration and an operation of the input control circuit 11 will be described with reference to FIG. 2 later.

The first operation control circuit 12 may control a read operation of the first cell array 13 in response to the read signal RDS and the read address RADD. The first operation control circuit 12 may control the first cell array 13 so that data stored in the cells of the first cell array 13 selected by the read address RADD are outputted as first read data RDATA1 and second read data RDATA2 while the read signal RDS is enabled.

The arithmetic circuit 14 may generate first write data WDATA1 and second write data WDATA2 from the first read data RDATA1 and the second read data RDATA2, in response to the arithmetic control signal AR_CNT<1:M>. The arithmetic circuit 14 may receive the first read data RDATA1 and the second read data RDATA2 to perform various operations and to generate the first write data WDATA1 and the second write data WDATA2, in order to perform an arithmetic operation which is set by the arithmetic control signal AR_CNT<1:M>. The arithmetic operation set by the arithmetic control signal AR_CNT<1:M> may be set to be different according to the embodiments. The arithmetic operation may include, for example but not limited to, an add operation, a multiply operation, a subtract operation, a logical AND operation, a logical OR operation, an exclusive logical OR operation, an invert operation, a shift operation and an error correction operation. The number “M” of bits included in the arithmetic control signal AR_CNT<1:M> may be set to be different according to the embodiments.[Original paragraph 20

The second operation control circuit 15 may control a write operation of the second cell array 16 in response to the write signal WTS and the write address WADD. The second operation control circuit 15 may control the second cell array 16 so that the first write data WDATA1 and the second write data WDATA2 are stored into the cells of the second cell array 16 selected by the write address WADD while the write signal WTS is enabled.

Referring to FIG. 2, the input control circuit 11 may include a command decoder 111, a read signal generation circuit 112, an arithmetic control signal generation circuit 113, a delay signal generation circuit 114, a write signal generation circuit 115 and an address generation circuit 116.

The command decoder 111 may decode the command CMD to generate an internal command RMW. The internal command RMW may be enabled to perform an operation that modifies data outputted from the first cell array 13 by a read operation using a predetermined arithmetic operation and stores the modified data into cells of the second cell array 16 using a write operation.

The read signal generation circuit 112 may generate the read signal RDS in response to the internal command RMW. The read signal generation circuit 112 may generate the read signal RDS which is enabled in synchronization with a point of time that the internal command RMW is enabled.

The arithmetic control signal generation circuit 113 may generate the arithmetic control signal AR_CNT<1:M> in response to the command CMD and the address ADD. The arithmetic control signal generation circuit 113 may output signals, which are inputted through the command CMD and the address ADD, as the arithmetic control signal AR_CNT<1:M>. The arithmetic control signal generation circuit 113 may perform a predetermined arithmetic operation of signals, which are inputted through the command CMD and the address ADD, to generate the arithmetic control signal AR_CNT<1:M> according to the embodiments. The arithmetic control signal generation circuit 113 may generate the arithmetic control signal AR_CNT<1:M> from the signals, which are inputted through any one of the command CMD and the address ADD, according to the embodiments. In some embodiments, the arithmetic control signal generation circuit 113 may receive the arithmetic control signal AR_CNT<1:M> from an external device or may generate the arithmetic control signal AR_CNT<1:M>, regardless of the command CMD and the address ADD.

The delay signal generation circuit 114 may generate a delay signal DLY from the internal command RMW in response to the arithmetic control signal AR_CNT<1:M>. The delay signal generation circuit 114 may generate the delay signal DLY which is enabled after a delay time set by the arithmetic control signal AR_CNT<1:M> elapses from a point of time that the internal command RMW is enabled. The delay time set by the arithmetic control signal AR_CNT<1:M> may be set to be different according to the embodiments. The delay signal generation circuit 114 may generate the delay signal DLY using only one or some bits among the bits included in the arithmetic control signal AR_CNT<1:M> according to the embodiments. In some embodiments, the delay signal generation circuit 114 may receive the delay signal DLY from an external device or may generate the delay signal DLY, regardless of the arithmetic control signal AR_CNT<1:M>.

The write signal generation circuit 115 may generate the write signal WTS in response to the delay signal DLY. The write signal generation circuit 115 may generate the write signal WTS which is enabled in synchronization with a point of time that the delay signal DLY is enabled.

The address generation circuit 116 may decode the address ADD to generate the read address RADD and the write address WADD, in response to the internal command RMW and the delay signal DLY. The address generation circuit 116 may decode the address ADD to generate the read address RADD if the internal command RMW is enabled. The address generation circuit 116 may decode the address ADD to generate the write address WADD if the delay signal DLY is enabled.

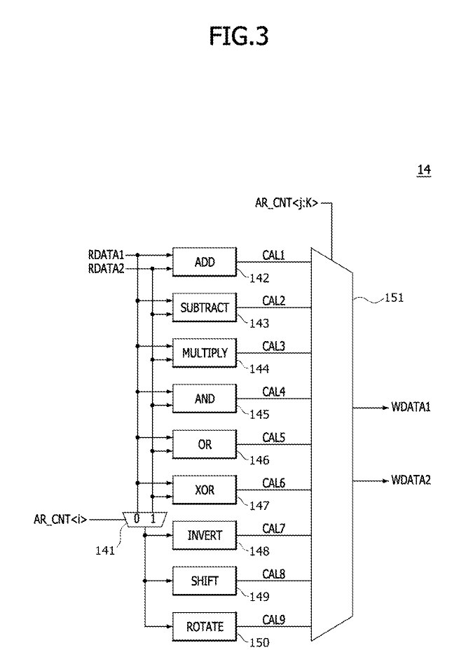

Referring to FIG. 3, the arithmetic circuit 14 may include a selector 141, a first arithmetic element 142, a second arithmetic element 143, a third arithmetic element 144, a fourth arithmetic element 145, a fifth arithmetic element 146, a sixth arithmetic element 147, a seventh arithmetic element 148, an eighth arithmetic element 149, a ninth arithmetic element 150 and an arithmetic operation selection circuit 151.

The selector 141 may receive the first read data RDATA1 and the second read data RDATA2 to output any one of the first read data RDATA1 and the second read data RDATA2, in response to a bit AR_CNT<i> included in the arithmetic control signal AR_CNT<1:M>. The first arithmetic element 142 may receive the first read data RDATA1 and the second read data RDATA2 and may perform an add operation of the first read data RDATA1 and the second read data RDATA2 to generate a first calculation signal CAL1. The second arithmetic element 143 may receive the first read data RDATA1 and the second read data RDATA2 and may perform a subtract operation between the first read data RDATA1 and the second read data RDATA2 to generate a second calculation signal CAL2. The third arithmetic element 144 may receive the first read data RDATA1 and the second read data RDATA2 and may perform a multiply operation of the first read data RDATA1 and the second read data RDATA2 to generate a third calculation signal CAL3. The fourth arithmetic element 145 may receive the first read data RDATA1 and the second read data RDATA2 and may perform a logical AND operation of the first read data RDATA1 and the second read data RDATA2 to generate a fourth calculation signal CAL4. The fifth arithmetic element 146 may receive the first read data RDATA1 and the second read data RDATA2 and may perform a logical OR operation of the first read data RDATA1 and the second read data RDATA2 to generate a fifth calculation signal CAL5. The sixth arithmetic element 147 may receive the first read data RDATA1 and the second read data RDATA2 and may perform a logical XOR operation of the first read data RDATA1 and the second read data RDATA2 to generate a sixth calculation signal CAL6. The seventh arithmetic element 148 may invert an output signal of the selector 141 to generate a seventh calculation signal CAL7. The eighth arithmetic element 149 may shift an output signal of the selector 141 to generate an eighth calculation signal CAL8. The ninth arithmetic element 150 may rotate an output signal of the selector 141 to generate a ninth calculation signal CAL9.

The arithmetic operation selection circuit 151 may generate the first and second write data WDATA1 and WDATA2 from the first to ninth calculation signals CAL1˜CAL9 in response to bits AR_CNT<j:k> included in the arithmetic control signal AR_CNT<1:M>. The arithmetic operation selection circuit 151 may selectively perform any one of various arithmetic operations of the first to ninth calculation signals CAL1˜CAL9 to generate the first and second write data WDATA1 and WDATA2, according to a logic level combination of the bits AR_CNT<j:k> included in the arithmetic control signal AR_CNT<1:M>. The various arithmetic operations of the first to ninth calculation signals CAL1˜CAL9 performed according to various logic level combinations of the bits AR_CNT<j:k> included in the arithmetic control signal AR_CNT<1:M> may be set to be different according to the embodiments.

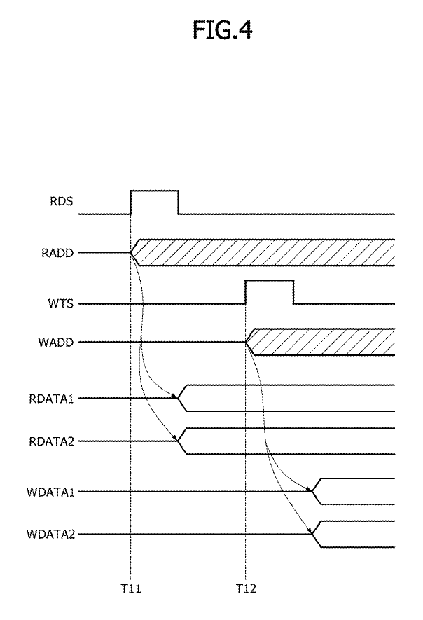

An operation of the semiconductor device having an aforementioned configuration will be described hereinafter with reference to FIG. 4 under the assumption that the internal command RMW is enabled to perform an operation that modifies data outputted from the first cell array 13 using a predetermined arithmetic operation during a read operation and stores the modified data into cells of the second cell array 16 during a write operation.

At a point of time “T11”, if the read signal RDS which is enabled, a read operation of cells included in the first cell array 13 and selected by the read address RADD may be performed to output the first and second read data RDATA1 and RDATA2 from the first cell array 13.

At a point of time “T12” delayed from the point of time “T11” by a predetermined time, the write signal WTS may be enabled and a write operation of cells included in the second cell array 16 and selected by the write address WADD may be performed to store the first and second write data WDATA1 and WDATA2 into the second cell array 16.

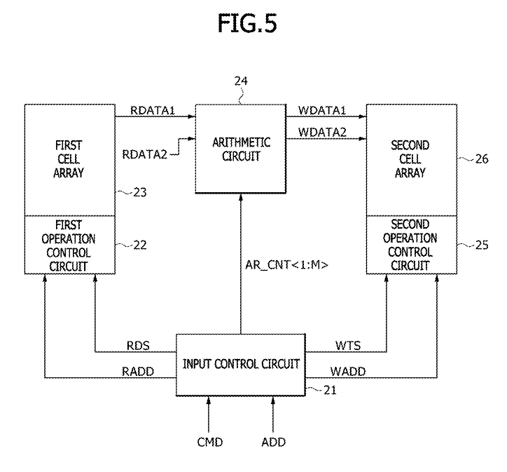

Referring to FIG. 5, a semiconductor device according to an embodiment may include an input control circuit 21, a first operation control circuit 22, a first cell array 23, an arithmetic circuit 24, a second operation control circuit 25 and a second cell array 26.

The input control circuit 21 may generate a read signal RDS, a read address RADD, a write signal WTS, a write address WADD and an arithmetic control signal AR_CNT<1:M> in response to a command CMD and an address ADD. In some embodiments, the command CMD and the address ADD may be transmitted through the same signal line. Each of the command CMD and the address ADD may be a signal including a plurality of bits according to the embodiments. The input control circuit 21 may decode the command CMD to generate the read signal RDS and the write signal WTS. The read signal RDS may be enabled to perform a read operation of the first cell array 23. The write signal WTS may be enabled to perform a write operation of the second cell array 26. The input control circuit 21 may decode the address ADD to generate the read address RADD and the write address WADD. The read address RADD may include a plurality of bits according to the embodiments. At least one among cells included in the first cell array 23 may be selected according to a logic level combination of bits included in the read address RADD, and data of the selected cell of the first cell array 23 may be read out while the read signal RDS is enabled. The write address WADD may include a plurality of bits according to the embodiments. At least one among cells included in the second cell array 26 may be selected according to a logic level combination of bits included in the write address WADD, and data may be stored into the selected cell of the second cell array 26 while the write signal WTS is enabled. In some embodiments, the arithmetic control signal AR_CNT<1:M> may be provided from an external device or may be generated in the semiconductor device. The arithmetic control signal AR_CNT<1:M> may be generated from a signal which is inputted through at least one of the command CMD and the address ADD according to the embodiments.

In an embodiment, the input control circuit 21 may generate a read signal RDS, a read address RADD, a write signal WTS, a write address WADD and an arithmetic control signal AR_CNT<1:M> in response to an external control signal ECS. The external control signal ECS may be received by the input control circuit 21. The external control signal ECS may originate from outside the semiconductor device and may be received externally from the semiconductor device by the input control circuit 21. The external control signal ECS may include at least one of a command CMD and/or an address ADD.

The first operation control circuit 22 may control a read operation of the first cell array 23 in response to the read signal RDS and the read address RADD. The first operation control circuit 22 may control the first cell array 23 so that data stored in the cells of the first cell array 23 selected by the read address RADD are outputted as first read data RDATA1 while the read signal RDS is enabled.

The arithmetic circuit 24 may generate first write data WDATA1 and second write data WDATA2 from the first read data RDATA1 and second read data RDATA2, in response to the arithmetic control signal AR_CNT<1:M>. The second read data RDATA2 may be provided from an external device or may be generated in the semiconductor device regardless of the first cell array 23. In an embodiment, the second read data RDATA2 may be received externally from the semiconductor device by the arithmetic circuit 24. The arithmetic circuit 24 may receive the first read data RDATA1 and the second read data RDATA2 to perform various operations and to generate the first write data WDATA1 and the second write data WDATA2, in order to perform an arithmetic operation which is set by the arithmetic control signal AR_CNT<1:M>. The arithmetic operation set by the arithmetic control signal AR_CNT<1:M> may be set to be different according to the embodiments. The arithmetic operation may include an add operation, a multiply operation, a subtract operation, a logical AND operation, a logical OR operation, an exclusive logical OR operation, an invert operation, a shift operation and an error correction operation. The number “M” of bits included in the arithmetic control signal AR_CNT<1:M> may be set to be different according to the embodiments.

The second operation control circuit 25 may control a write operation of the second cell array 26 in response to the write signal WTS and the write address WADD. The second operation control circuit 25 may control the second cell array 26 so that the first write data WDATA1 and the second write data WDATA2 are stored into the cells of the second cell array 26 selected by the write address WADD while the write signal WTS is enabled.

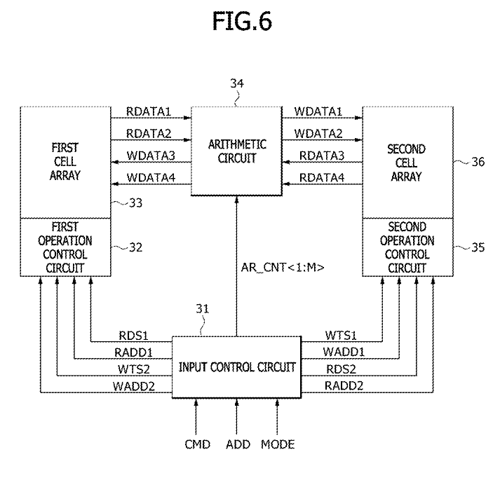

Referring to FIG. 6, a semiconductor device according to an embodiment may include an input control circuit 31, a first operation control circuit 32, a first cell array 33, an arithmetic circuit 34, a second operation control circuit 35 and a second cell array 36.

The input control circuit 31 may generate a first read signal RDS1, a first read address RADD1, a second read signal RDS2, a second read address RADD2, a first write signal WTS1, a first write address WADD1, a second write signal WTS2, a second write address WADD2 and an arithmetic control signal AR_CNT<1:M> in response to a command CMD, an address ADD and a mode signal MODE. In some embodiments, the command CMD and the address ADD may be transmitted through the same signal line. Each of the command CMD and the address ADD may be a signal including a plurality of bits according to the embodiments. The mode signal MODE may be set to have a first logic level if a read operation of the first cell array 33 is performed and a write operation of the second cell array 36 is performed. The mode signal MODE may be set to have a second logic level if a read operation of the second cell array 36 is performed and a write operation of the first cell array 33 is performed. The first and second logic levels of the mode signal MODE may be set to be different according to the embodiments.

In an embodiment, the input control circuit 31 may generate a first read signal RDS1, a first read address RADD1, a second read signal RDS2, a second read address RADD2, a first write signal WTS1, a first write address WADD1, a second write signal WTS2, a second write address WADD2 and an arithmetic control signal AR_CNT<1:M> in response to an external control signal ECS and a mode signal. The external control signal ECS may be received by the input control circuit 31. The external control signal ECS may originate from outside the semiconductor device and may be received externally from the semiconductor device by the input control circuit 31. The external control signal ECS may include at least one of a command CMD and/or an address ADD.

The input control circuit 31 may decode the command CMD to generate the first read signal RDS1 and the first write signal WTS1 if the mode signal MODE has the first logic level. The first read signal RDS1 may be enabled to perform a read operation of the first cell array 33. The first write signal WTS1 may be enabled to perform a write operation of the second cell array 36. The input control circuit 31 may decode the address ADD to generate the first read address RADD1 and the first write address WADD1 if the mode signal MODE has the first logic level. The first read address RADD1 may include a plurality of bits according to the embodiments. At least one among cells included in the first cell array 33 may be selected according to a logic level combination of bits included in the first read address RADD1, and data of the selected cell of the first cell array 33 may be read out while the first read signal RDS1 is enabled. The first write address WADD1 may include a plurality of bits according to the embodiments. At least one among cells included in the second cell array 36 may be selected according to a logic level combination of bits included in the first write address WADD1, and data may be stored into the selected cell of the second cell array 36 while the first write signal WTS1 is enabled.

The input control circuit 31 may decode the command CMD to generate the second read signal RDS2 and the second write signal WTS2 if the mode signal MODE has the second logic level. The second read signal RDS2 may be enabled to perform a read operation of the second cell array 36. The second write signal WTS2 may be enabled to perform a write operation of the first cell array 33. The input control circuit 31 may decode the address ADD to generate the second read address RADD2 and the second write address WADD2 if the mode signal MODE has the second logic level. The second read address RADD2 may include a plurality of bits according to the embodiments. At least one among cells included in the second cell array 36 may be selected according to a logic level combination of bits included in the second read address RADD2, and data of the selected cell of the second cell array 36 may be read out while the second read signal RDS2 is enabled. The second write address WADD2 may include a plurality of bits according to the embodiments. At least one among cells included in the first cell array 33 may be selected according to a logic level combination of bits included in the second write address WADD2, and data may be stored into the selected cell of the first cell array 33 while the second write signal WTS2 is enabled.

In some embodiments, the arithmetic control signal AR_CNT<1:M> may be provided from an external device or may be generated in the semiconductor device. The arithmetic control signal AR_CNT<1:M> may be generated from a signal which is inputted through at least one of the command CMD and the address ADD according to the embodiments.

The first operation control circuit 32 may control a read operation of the first cell array 33 in response to the first read signal RDS1 and the first read address RADD1 if the mode signal MODE has the first logic level. The first operation control circuit 32 may control the first cell array 33 so that data stored in the cells of the first cell array 33 selected by the first read address RADD1 are outputted as first read data RDATA1 and second read data RDATA2 while the first read signal RDS1 is enabled. The first operation control circuit 32 may control a write operation of the first cell array 33 in response to the second write signal WTS2 and the second write address WADD2 if the mode signal MODE has the second logic level. The first operation control circuit 32 may control the first cell array 33 so that third write data WDATA3 and fourth write data WDATA4 are stored into the cells of the first cell array 33 selected by the second write address WADD2 while the second write signal WTS2 is enabled.

The arithmetic circuit 34 may generate first write data WDATA1 and second write data WDATA2 from the first read data RDATA1 and the second read data RDATA2 in response to the arithmetic control signal AR_CNT<1:M>, if the mode signal MODE has the first logic level. The arithmetic circuit 34 may receive the first read data RDATA1 and the second read data RDATA2 to perform various operations and to generate the first write data WDATA1 and the second write data WDATA2, in order to perform an arithmetic operation which is set by the arithmetic control signal AR_CNT<1:M>. The arithmetic circuit 34 may generate the third write data WDATA3 and the fourth write data WDATA4 from third read data RDATA3 and fourth read data RDATA4 in response to the arithmetic control signal AR_CNT<1:M>, if the mode signal MODE has the second logic level. The arithmetic circuit 34 may receive the third read data RDATA3 and the fourth read data RDATA4 to perform various operations and to generate the third write data WDATA3 and the fourth write data WDATA4, in order to perform an arithmetic operation which is set by the arithmetic control signal AR_CNT<1:M>. The arithmetic operation set by the arithmetic control signal AR_CNT<1:M> may be set to be different according to the embodiments. The arithmetic operation may include an add operation, a multiply operation, a subtract operation, a logical AND operation, a logical OR operation, an exclusive logical OR operation, an invert operation, a shift operation and an error correction operation. The number “M” of bits included in the arithmetic control signal AR_CNT<1:M> may be set to be different according to the embodiments.

The second operation control circuit 35 may control a write operation of the second cell array 36 in response to the first write signal WTS1 and the first write address WADD1, if the mode signal MODE has the first logic level. The second operation control circuit 35 may control the second cell array 36 so that the first write data WDATA1 and the second write data WDATA2 are stored into the cells of the second cell array 36 selected by the first write address WADD1 while the first write signal WTS1 is enabled. The second operation control circuit 35 may control a read operation of the second cell array 36 in response to the second read signal RDS2 and the second read address RADD2 if the mode signal MODE has the second logic level. The second operation control circuit 35 may control the second cell array 36 so that data stored in the cells of the second cell array 36 selected by the second read address RADD2 are outputted as the third read data RDATA3 and the fourth read data RDATA4 while the second read signal RDS2 is enabled.

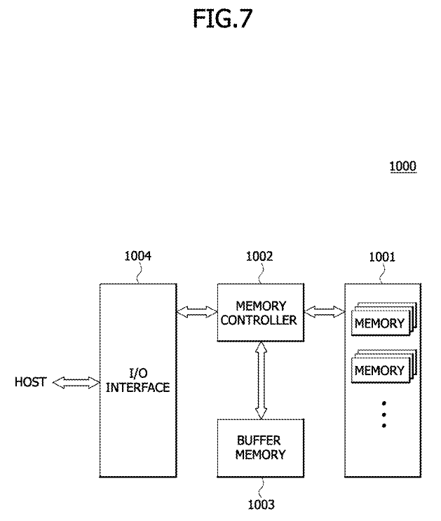

At least one of the semiconductor devices described with reference to FIGS. 1, 5 and 6 may be applied to an electronic system that includes a memory system, a graphic system, a computing system, a mobile system, or the like. For example, as illustrated in FIG. 7, an electronic system 1000 according an embodiment may include a data storage circuit 1001, a memory controller 1002, a buffer memory 1003, and an input and or output (input/output) (I/O) interface 1004.

The data storage circuit 1001 may store data which are outputted from the memory controller 1002 or may read and output the stored data to the memory controller 1002, according to a control signal generated by the memory controller 1002. The data storage circuit 1001 may include at least one of the semiconductor devices illustrated or discussed with regards to FIGS. 1, 5 and 6. The data storage circuit 1001 may include a nonvolatile memory that can retain their stored data even when its power supply is interrupted. The nonvolatile memory may be a flash memory such as a NOR-type flash memory or a NAND-type flash memory, a phase change random access memory (PRAM), a resistive random access memory (RRAM), a spin transfer torque random access memory (STTRAM), a magnetic random access memory (MRAM), or the like.

The memory controller 1002 may receive a command outputted from an external device (e.g., a host device) through the I/O interface 1004 and may decode the command outputted from the host device to control an operation for inputting data into the data storage circuit 1001 or the buffer memory 1003 or for outputting the data stored in the data storage circuit 1001 or the buffer memory 1003. Although FIG. 7 illustrates the memory controller 1002 with a single block, the memory controller 1002 may include one controller for controlling the data storage circuit 1001 comprised of a nonvolatile memory and another controller for controlling the buffer memory 1003 comprised of a volatile memory.

The buffer memory 1003 may temporarily store the data which are processed by the memory controller 1002. That is, the buffer memory 1003 may temporarily store the data which are outputted from or to be inputted to the data storage circuit 1001. The buffer memory 1003 may store the data, which are outputted from the memory controller 1002, according to a control signal. The buffer memory 1003 may read and output the stored data to the memory controller 1002. The buffer memory 1003 may include a volatile memory such as a dynamic random access memory (DRAM), a mobile DRAM, or a static random access memory (SRAM).

The I/O interface 1004 may physically and electrically connect the memory controller 1002 to the external device (i.e., the host). Thus, the memory controller 1002 may receive control signals and data supplied from the external device (i.e., the host) through the I/O interface 1004 and may output the data generated from the memory controller 1002 to the external device (i.e., the host) through the I/O interface 1004. That is, the electronic system 1000 may communicate with the host through the I/O interface 1004. The I/O interface 1004 may include any one of various interface protocols such as a universal serial bus (USB), a multi-media card (MMC), a peripheral component interconnect-express (PCI-E), a serial attached SCSI (SAS), a serial AT attachment (SATA), a parallel AT attachment (PATA), a small computer system interface (SCSI), an enhanced small device interface (ESDI) and an integrated drive electronics (IDE).

The electronic system 1000 may be used as an auxiliary storage device of the host or an external storage device. The electronic system 1000 may include a solid state disk (SSD), a USB memory, a secure digital (SD) card, a mini secure digital (mSD) card, a micro secure digital (micro SD) card, a secure digital high capacity (SDHC) card, a memory stick card, a smart media (SM) card, a multi-media card (MMC), an embedded multi-media card (eMMC), a compact flash (CF) card, or the like.

As described above, each of semiconductor devices according to the embodiments may include an arithmetic circuit to perform an arithmetic operation for achieving a specific function. Thus, an amount of current required for data transmission between a controller and the semiconductor device may be reduced.

What is claimed is:

1. A semiconductor device comprising:
an input control circuit configured to generate a read signal, a read address, a write signal and a write address based on an external control signal;
a first operation control circuit configured to control a first cell array so that first read data and second read data stored in the first cell array are outputted based on the read signal and the read address;
an arithmetic circuit configured to perform a predetermined arithmetic operation to generate first write data and second write data based on the first read data and the second read data; and
a second operation control circuit configured to control a second cell array so that the first write data and the second write data are stored in the second cell array based on the write signal and the write address.

2. The semiconductor device of claim 1, wherein the external control signal includes at least one of a command and an address.

3. The semiconductor device of claim 1,
wherein the read signal is enabled while a read operation of the first cell array is performed; and
wherein the read address has a logic level combination for selecting cells included in the first cell array storing the first and second read data.

4. The semiconductor device of claim 1,
wherein the write signal is enabled while a write operation of the second cell array is performed; and
wherein the write address has a logic level combination for selecting cells included in the second cell array storing the first and second write data.

5. The semiconductor device of claim 1, wherein the input control circuit includes:
a command decoder configured to decode a command to generate an internal command;
a read signal generation circuit configured to generate the read signal based on the internal command;
a delay signal generation circuit configured to generate a delay signal based on the internal command; and
a write signal generation circuit configured to generate the write signal based on the delay signal.

6. The semiconductor device of claim 5, wherein the input control circuit further comprises:
an arithmetic control signal generation circuit configured to generate an arithmetic control signal based on the external control signal; and
an address generation circuit configured to decode an address from the external control signal to generate a read address and write address based on the internal command and delay signal,
wherein the delay signal generation circuit is configured to generate the delay signal based on the internal command and the arithmetic control signal.

7. The semiconductor device of claim 5, wherein the internal command in enabled to perform a write operation of the second cell array at a point of time that a predetermined time elapses after a read operation of the first cell array is performed.

8. The semiconductor device of claim 5, wherein the input control circuit further includes an address generation circuit configured to decode an address to generate the read address and the write address based on the internal command and a delay signal.

9. The semiconductor device of claim 8,
wherein the address generation circuit decodes the address to generate the read address if the internal command is enabled; and
wherein the address generation circuit decodes the address to generate the write address if the delay signal is enabled.

10. The semiconductor device of claim 5, wherein the delay signal generation circuit delays the internal command by a delay time, which is set by an arithmetic control signal, to generate the delay signal.

11. The semiconductor device of claim 1, wherein the input control circuit generates an arithmetic control signal based on the external control signal.

12. The semiconductor device of claim 11, wherein the predetermined arithmetic operation performed by the arithmetic circuit is determined according to a logic level combination of the arithmetic control signal.

13. A semiconductor device comprising:
an input control circuit configured to generate a read signal, a read address, a write signal and a write address based on an external control signal;
a first operation control circuit configured to control a first cell array so that first read data stored in the first cell array is outputted based on the read signal and the read address;
an arithmetic circuit configured to perform a predetermined arithmetic operation to generate first write data and second write data based on the first read data and second read data; and
a second operation control circuit configured to control a second cell array so that the first write data and the second write data are stored in the second cell array based on the write signal and the write address.

14. The semiconductor device of claim 13, wherein the second read data is provided externally from the semiconductor device.

15. The semiconductor device of claim 13, wherein the external control signal includes at least one of a command and an address.

16. A semiconductor device comprising:
an input control circuit configured to generate a first read signal, a first read address, a second read signal, a second read address, a first write signal, a first write address, a second write signal and a second write address based on an external control signal and a mode signal;
an arithmetic circuit configured to perform a predetermined arithmetic operation to generate first write data based on first read data if the mode signal has a first logic level and configured to perform the predetermined arithmetic operation to generate second write data based on second read data if the mode signal has a second logic level; and
a first operation control circuit configured to control a first cell array so that the first read data stored in the first cell array are outputted based on the first read signal and the first read address if the mode signal has the first logic level and configured to control the first cell array so that the second write data are stored in the first cell array based on the second write signal and the second write address if the mode signal has the second logic level.

17. The semiconductor device of claim 16, wherein a logic level of the mode signal is set by at least one of a command and an address.

18. The semiconductor device of claim 16,
wherein the first read signal is enabled to perform a read operation of the first cell array while the mode signal has the first logic level; and
wherein the first read address has a logic level combination for selecting cells included in the first cell array storing the first read data while the mode signal has the first logic level.

19. The semiconductor device of claim 16,
wherein the second write signal is enabled to perform a write operation of the first cell array while the mode signal has the second logic level; and
wherein the second write address has a logic level combination for selecting cells included in the first cell array to store the second write data while the mode signal has the first logic level.

20. The semiconductor device of claim 16, further comprising a second operation control circuit configured to control a second cell array so that the first write data are stored in the second cell array based on the first write signal and the first write address if the mode signal has the first logic level and configured to control the second cell array so that the second read data stored in the second cell array are outputted based on the second read signal and the second read address if the mode signal has the second logic level.

21. The semiconductor device of claim 20,
wherein the first write signal is enabled to perform a write operation of the second cell array while the mode signal has the first logic level;
wherein the first write address has a logic level combination for selecting cells included in the second cell array storing the first write data while the mode signal has the first logic level;
wherein the second read signal is enabled to perform a read operation of the second cell array while the mode signal has the second logic level; and
wherein the second read address has a logic level combination for selecting cells included in the second cell array storing the second read data while the mode signal has the second logic level.
